(19) United States
(12) Patent Application Publication
(10) Pub. No.: US 2020/0224078 A1
(43) Pub. Date: Jul. 16, 2020

(54) METHODS AND COMPOSITIONS FOR CONTROLLING EXCESS WATER PRODUCTION

(71) Applicant: SAUDI ARABIAN OIL COMPANY, Dhahran (SA)

(72) Inventors: Rajesh Kumar SAINI, Cypress, TX (US); Leiming LI, Sugarland, TX (US); Shawn RIMASSA, Katy, TX (US); Amy J. CAIRNS, Houston, TX (US)

(73) Assignee: SAUDI ARABIAN OIL COMPANY, Dhahran (SA)

(21) Appl. No.: 16/741,137

(22) Filed: Jan. 13, 2020

Related U.S. Application Data
(60) Provisional application No. 62/791,308, filed on Jan. 11, 2019.

(51) Int. Cl. C09K 8/502; E21B 33/138

(52) U.S. Cl. CPC C09K 8/502; E21B 33/138

(57) ABSTRACT

Embodiments relate to methods and compositions for controlling excess water production for hydrocarbon recovery. According to an embodiment, the method includes a treatment fluid composition. The treatment fluid composition includes a monomer and a latent acid. The treatment fluid composition is introduced downhole where it is positioned in a water-bearing region of a hydrocarbon-bearing formation. An acid catalyst is formed by hydrolysis or decomposition of the latent acid in the water-bearing region. The acid catalyst is used to polymerize the monomer to form a resin. The resin blocks water from permeating from the water-bearing region into the wellbore.

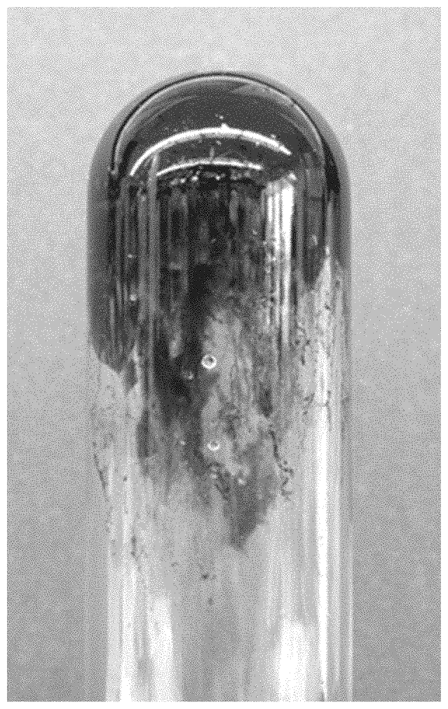

### RELATED APPLICATION

The disclosure is related to, and claims priority from, U.S. Provisional Patent Application 62/791,308, filed on Jan. 11, 2019, the disclosure of which is incorporated herein by reference in its entirety.

### BACKGROUND

### 1. Field

Embodiments generally relate to hydrocarbon recovery. More particularly, embodiments relate to methods and compositions for controlling excess water production to facilitate hydrocarbon recovery.

### 2. Description of the Related Art

Water (or aqueous fluids) is often produced from oil and gas wells as a non-desirable byproduct, especially when the oil and gas wells are near subterranean water sources or the wells are located offshore. In such environments, it is inevitable to completely shut off the produced water. Because water cannot be completely shut off during certain hydrocarbon production operations, the produced water is subsequently separated from the produced hydrocarbons. Once the produced water is separated from the produced hydrocarbons, the water is disposed of in an environmentally-friendly manner.

In certain cases, water is produced in a greater amount such that the separation and the disposition of the produced water becomes burdensome in terms of hydrocarbon production. Here, the produced water is called “excess water” as known in the art.

A number of conventional means exist for controlling excess water production. In cases where excess water does not contain hazardous substances, it can be reinjected in disposal injection wells. The produce water can be used in hydraulic fracturing of a hydrocarbon-bearing formation. Also, the produced water can be disposed onshore or offshore. In cases where excess water contains hazardous substances, it is necessary to treat the excess water to remove those substances before conducting any subsequent reinjection or disposal events.

### SUMMARY

Excess water production from oil and gas wells results in reduced hydrocarbon recovery and increased operational cost. The produced water may negatively affect the environment, especially when the produced water contains hazardous substances. Given that the produced water does not contain hazardous substances, the produced water can be handled in a number of ways. The produced water can be reinjected in disposal injection wells or used in hydraulic fracturing of the hydrocarbon-bearing formation. The produced water can be disposed onshore or offshore. In cases where hazardous substances are present in the produced water, post-production treatment is required before the produced water is reinjected in disposal wells or disposed on shore or offshore. Post-production water treatment corresponds to increased operation costs and early abandonment of the well.

Conventionally available options for controlling excess water production include mechanical and chemical operations. Examples of mechanical operations include using tubing patches, casing patches, bridge plugs, straddle packers, scab liners, and cement squeeze. These mechanical means are used to seal certain perforations of wellbore hardware or near-wellbore openings.

In the alternative, chemical means are used in cases where mechanical means are not available. Chemical means are used to achieve matrix or fissure sealing for controlling water flow. Chemical means are used to selectively seal and reduce unwanted water flow from an offending zone to permit flow from the oil zone. Chemical means are used to modify relative permeability of oil to water. Chemical means are used to seal off depleted zones. Chemical means are used to block certain high permeability streaks such that subterranean water does not reach the wellbore. High permeability streaks have a relatively greater permeability enough for subterranean water to pass through in wellbore conditions without added pressure.

Many chemicals or chemical compositions are available for chemical operations to mitigate excessive water production problems. Examples of chemicals or chemical compositions used in chemical operations include inorganic gels, resins, elastomers, monomer-based systems, crosslinked rigid polymer gels, crosslinked flowing polymer gels, flowing gels, ungelled polymers, viscous systems, bio-polymers, and grouting materials. Precise positioning of the chemicals or chemical compositions are usually required to effectively seal the water zone in chemical operations. Precise positioning may involve using coiled tubing to deliver the chemicals or chemical compositions to a desired location.

A relative permeability modifier (RPM) can be effective in mitigating excess water production. An RPM generally includes one or more compounds injected into a formation that adsorb onto the rock surface thereby reducing the water permeability of the formation and maintaining the oil permeability intact. However, the drawback is that RPM operations often suffer from reduced oil permeability that negatively impacts hydrocarbon recovery. Examples of chemicals or chemical compositions used in chemical operations as RPMs include ungelled polymers and viscous systems.

In fact, most of the chemical operations available for excess water control do not provide complete water control without sacrificing oil production. The chemical operations available for excess water control also suffer from a number of disadvantages. These disadvantages include crosslinking of a gel before placement, relatively lesser gel strength, limited depth of matrix invasion, chemical incompatibility with formation ions, chemical incompatibility with brines, use of hazardous or expensive chemicals, complete blockage of the formation, and instability of the polymer gel resulting in syneresis, precipitation, and breakage.

Therefore, this disclosure presents embodiments related to methods and compositions for controlling excess water production for hydrocarbon recovery. The methods and compositions disclosed here significantly reduce water production by inhibiting water from permeating from a water-bearing region of a hydrocarbon-bearing formation into a wellbore. The methods and compositions disclosed here are configured to selectively plug the water producing zones without precise positioning of the chemicals or chemical compositions using, for example, coiled tubing, or other means. Instead, the chemical can be bullheaded directly into the formation. The bullheaded chemicals located in the water-bearing region will react to plug the water-bearing region. At the same time, the methods and compositions minimally affect oil and gas production, as opposed to using RPMs, or other chemical means. The bullheaded chemicals in the oil-bearing region would not react and therefore would not plug the oil bearing region.

Embodiments provide a method for controlling excess water production for hydrocarbon recovery. The method includes the step of introducing a monomer and a latent acid into a hydrocarbon-bearing formation via a wellbore. The method includes the step of polymerizing the monomer using an acid catalyst to form a resin. The acid catalyst is formed by hydrolysis of the latent acid in a water-bearing region of the hydrocarbon-bearing formation. The resin inhibits water from permeating from the water-bearing region to the wellbore.

In some embodiments, the monomer includes a furan-based alcohol, a furan-based aldehyde, a formaldehyde-based monomer, a ketone-based monomer, a phenol-based monomer, a methylol-based monomer, and combinations of the same. In some embodiments, the latent acid includes a carboxylic acid ester, a sulfonic acid ester, a polyester, an anhydride, an orthoester, and combinations of the same. In some embodiments, the resin is a furan-based resin. In some embodiments, the introducing step further includes introducing a viscosity-enhancing additive, a sealing additive, a solid acid additive, a water-absorbing additive, a solvent, a coupling agent, and combinations of the same. In some embodiments, the resin is a prepolymer novolac-type resin. In some embodiments, the method further includes the step of curing the resin by applying heat and introducing formaldehyde, hexamethylenetetramine, a crosslinking agent, and combinations of the same.

Embodiments provide a method for controlling excess water production for hydrocarbon recovery. The method includes the step of introducing a prepolymer and a latent acid into a hydrocarbon-bearing formation via a wellbore. The method includes the step of polymerizing the prepolymer using an acid catalyst to form a resin. The acid catalyst is formed by hydrolysis of the latent acid in a water-bearing region of the hydrocarbon-bearing formation. The resin inhibits water from permeating from the water-bearing region to the wellbore.

In some embodiments, the prepolymer includes a monomer unit having a furan-based alcohol, a furan-based aldehyde, a formaldehyde-based monomer, a ketone-based monomer, a phenol-based monomer, a methylol-based monomer, and combinations of the same. In some embodiments, the latent acid includes a carboxylic acid ester, a sulfonic acid ester, a polyester, an anhydride, an orthoester, and combinations of the same.

Embodiments provide a method for controlling excess water production for hydrocarbon recovery. The method includes the step of introducing a monomer and a latent acid into a hydrocarbon-bearing formation via a wellbore. The method includes the step of decomposing hydroxylamine. The method includes the step of polymerizing the monomer using an acid catalyst to form a resin. The latent acid includes the acid catalyst and the hydroxylamine. The hydroxylamine, before decomposition, retards the polymerizing step. The resin inhibits water from permeating from a water-bearing region of the hydrocarbon-bearing formation to the wellbore.

In some embodiments, the monomer includes a furan-based alcohol, a furan-based aldehyde, a formaldehyde-based monomer, a ketone-based monomer, a phenol-based monomer, a methylol-based monomer, and combinations of the same.

Embodiments provide a method for controlling excess water production for hydrocarbon recovery. The method includes the step of introducing a prepolymer and a latent acid into a hydrocarbon-bearing formation via a wellbore. The method includes the step of decomposing hydroxylamine. The method includes the step of polymerizing the prepolymer using the acid catalyst to form a resin. The latent acid includes an acid catalyst and the hydroxylamine. The hydroxylamine, before decomposition, retards the polymerizing step. The resin inhibits water from permeating from a water-bearing region of the hydrocarbon-bearing formation to the wellbore.

In some embodiments, the prepolymer includes a monomer unit having a furan-based alcohol, a furan-based aldehyde, a formaldehyde-based monomer, a ketone-based monomer, a phenol-based monomer, a methylol-based monomer, and combinations of the same.

Embodiments provide a treatment fluid composition for controlling excess water production for hydrocarbon recovery. The treatment fluid composition includes a monomer and a latent acid. The latent acid is configured to undergo hydrolysis in a water-bearing region of a hydrocarbon-bearing formation to form an acid catalyst. The acid catalyst is configured to catalyze polymerization of the monomer to form a resin. The resin is configured to inhibit water from permeating from the water-bearing region to a wellbore.

In some embodiments, the monomer includes a furan-based alcohol, a furan-based aldehyde, a formaldehyde-based monomer, a ketone-based monomer, a phenol-based monomer, a methylol-based monomer, and combinations of the same. In some embodiments, the furan-based alcohol is furfuryl alcohol. In some embodiments, the furan-based aldehyde is furfural. In some embodiments, the formaldehyde-based monomer is formaldehyde. In some embodiments, the phenol-based monomer includes phenol, cresol, resorcinol, cashew nutshell liquid distillate, and combinations of the same. In some embodiments, the methylol-based monomer includes dimethylol urea, methylol phenols, methylol melamines, and combinations of the same.

In some embodiments, the latent acid includes a carboxylic acid ester, a sulfonic acid ester, a polyester, an anhydride, an orthoester, and combinations of the same. In some embodiments, the carboxylic acid ester is an ester derived from a carboxylic acid including malonic acid, succinic acid, maleic acid, oxalic acid, acetic acid, lactic acid, malic acid, tartaric acid, benzoic acid, citric acid, and combinations of the same. In some embodiments, the sulfonic acid ester includes alkylsulfonic acid esters, haloalkylsulfonic acid esters, imino sulfonates, imido sulfonates, alkyl p-toluenesulfonate, p-toluenesulfonic acid methyl ester, n-butyl p-toluenesulfonate, benzenesulfonic acid methyl ester, methanesulfonic acid ethyl ester, and combinations of the same. In some embodiments, the polyester includes aliphatic polyesters, aromatic polyesters, polyhydroxybutyrates, polylactic acids, polyglycolic acids, polyorthoesters, polycaprolactones, polybutylene succinates, polyanhydrides, cellulose esters, cellulose acetates, polyhydroxyalkanoates, and combinations of the same. In some embodiments, the anhydride includes acetic anhydride, maleic anhydride, and combinations of the same. In some embodiments, the orthoester includes trimethyl orthoformate, trimethyl orthoacetate, triethyl orthoacetate, polyorthoesters, and combinations of the same.

In some embodiments, the treatment fluid composition further includes an additive. The additive includes a viscosity-enhancing additive, a sealing additive, a solid acid additive, a water-absorbing additive, a solvent, a coupling agent, and combinations of the same.

Embodiments provide a treatment fluid composition for controlling excess water production for hydrocarbon recovery. The treatment fluid composition includes a prepolymer and a latent acid. The latent acid is configured to undergo hydrolysis in a water-bearing region of a hydrocarbon-bearing formation to form an acid catalyst. The acid catalyst is configured to catalyze polymerization of the prepolymer to form a resin. The resin is configured to inhibit water from permeating from the water-bearing region to a wellbore.

In some embodiments, the prepolymer includes a monomer unit having a furan-based alcohol, a furan-based aldehyde, a formaldehyde-based monomer, a ketone-based monomer, a phenol-based monomer, a methylol-based monomer, and combinations of the same. In some embodiments, the latent acid includes a carboxylic acid ester, a sulfonic acid ester, a polyester, an anhydride, an orthoester, and combinations of the same.

Embodiments provide a treatment fluid composition for controlling excess water production for hydrocarbon recovery. The treatment fluid composition includes an oligomer and a latent acid. The latent acid is configured to undergo hydrolysis in a water-bearing region of a hydrocarbon-bearing formation to form an acid catalyst. The acid catalyst is configured to catalyze polymerization of the oligomer to form a resin. The resin is configured to inhibit water from permeating from the water-bearing region to a wellbore.

In some embodiments, the oligomer includes a monomer unit having a furan-based alcohol, a furan-based aldehyde, a formaldehyde-based monomer, a ketone-based monomer, a phenol-based monomer, a methylol-based monomer, and combinations of the same. In some embodiments, the latent acid includes a carboxylic acid ester, a sulfonic acid ester, a polyester, an anhydride, an orthoester, and combinations of the same.

Embodiments provide a treatment fluid composition for controlling excess water production for hydrocarbon recovery. The treatment fluid composition includes a monomer and a latent acid. The latent acid includes an acid catalyst and hydroxylamine. The hydroxylamine is configured to thermally decompose in a hydrocarbon-bearing formation. The acid catalyst is configured to catalyze polymerization of the monomer to form a resin upon decomposition of the hydroxylamine. The resin is configured to inhibit water from permeating from a water-bearing region of the hydrocarbon-bearing formation to a wellbore.

In some embodiments, the monomer includes a furan-based alcohol, a furan-based aldehyde, a formaldehyde-based monomer, a ketone-based monomer, a phenol-based monomer, a methylol-based monomer, and combinations of the same.

Embodiments provide a treatment fluid composition for controlling excess water production for hydrocarbon recovery. The treatment fluid composition includes a prepolymer and a latent acid. The latent acid includes an acid catalyst and hydroxylamine. The hydroxylamine is configured to thermally decompose in a hydrocarbon-bearing formation. The acid catalyst is configured to catalyze polymerization of the prepolymer to form a resin upon decomposition of the hydroxylamine. The resin is configured to inhibit water from permeating from a water-bearing region of the hydrocarbon-bearing formation to a wellbore.

In some embodiments, the prepolymer includes a monomer unit having a furan-based alcohol, a furan-based aldehyde, a formaldehyde-based monomer, a ketone-based monomer, a phenol-based monomer, a methylol-based monomer, and combinations of the same.

Embodiments provide a method for controlling excess water production for hydrocarbon recovery. The method includes the step of introducing a copolymer and a glycol ether solvent into a hydrocarbon-bearing formation via a wellbore. The copolymer and the glycol ether solvent forms a mixture in the hydrocarbon-bearing formation. The method includes the step of maintaining the mixture in the hydrocarbon-bearing formation until the glycol ether solvent dissolves in a water-bearing region of the hydrocarbon-bearing formation allowing the copolymer to undergo precipitation. The copolymer is oil-soluble. The precipitated copolymer inhibits water from permeating from the water-bearing region to the wellbore.

In some embodiments, the copolymer includes an ethylene-propylene-styrene copolymer, an ethylene-butylene-styrene copolymer, and combinations of the same. In some embodiments, the glycol ether solvent includes 2-methoxyethanol, 2-ethoxyethanol, 2-propoxyethanol, 2-isopropoxyethanol, 2-butoxyethanol, 2-phenoxyehtanol, 2-benzyloxyethanol, 1-methoxy-2-propanol, 2-(2-methoxyethoxy)ethanol, 2-(2-ethoxyethoxy)ethanol, 2-(2-butoxyethoxy)ethanol, and combinations of the same.

Embodiments provide a treatment fluid composition for controlling excess water production for hydrocarbon recovery. The treatment fluid composition includes a copolymer and a glycol ether solvent. The glycol ether solvent is configured to dissolve in a water-bearing region of a hydrocarbon-bearing formation such that the copolymer undergoes precipitation. The precipitated copolymer is configured to inhibit water from permeating from the water-bearing region of the hydrocarbon-bearing formation to a wellbore.

In some embodiments, the copolymer includes an ethylene-propylene-styrene copolymer, an ethylene-butylene-styrene copolymer, and combinations of the same. In some embodiments, the glycol ether solvent includes 2-methoxyethanol, 2-ethoxyethanol, 2-propoxyethanol, 2-isopropoxyethanol, 2-butoxyethanol, 2-phenoxyehtanol, 2-benzyloxyethanol, 1-methoxy-2-propanol, 2-(2-methoxyethoxy)ethanol, 2-(2-ethoxyethoxy)ethanol, 2-(2-butoxyethoxy)ethanol, and combinations of the same.

Embodiments provide a method for controlling excess water production for hydrocarbon recovery. The method includes the step of introducing a monomer, bisacrylamide, and a free radical-generating catalyst into a hydrocarbon-bearing formation via a wellbore. The method includes the step of polymerizing the monomer and the bisacrylamide using free radicals to form a polymer. The monomer is water-soluble. The free radical-generating catalyst is oil-soluble. The free radicals are formed by degradation of the free radical-generating catalyst in a water-bearing region of the hydrocarbon-bearing formation. The polymer inhibits water from permeating from the water-bearing region to the wellbore.

In some embodiments, the monomer includes an acrylamide monomer, an acrylate monomer, and combinations of the same. In some embodiments, the free radical-generating catalyst includes 2,2′-azobis(4-methoxy-2,4-dimethylvaleronitrile), 2,2′-azobis(2,4-dimethylvaleronitrile.), 2,2′-azobis(isobutyronitrile), 2,2′-azobis (2-methylbutyronitrile), 1,1′-azobis(cyclohexane-1-carbonitrile), dimethyl 2,2′-azobis(2-methylpropionate), 2,2′-azobis (N-butyl-2-methylpropionamide), and combinations of the same.

Embodiments provide a treatment fluid composition for controlling excess water production for hydrocarbon recovery. The treatment fluid composition includes a monomer, bisacrylamide, and a free radical-generating catalyst. The monomer and the bisacrylamide is configured to be solubilized in a hydrophilic environment. An external phase is produced by emulsifying the monomer and the bisacrylamide in a hydrophobic environment. The monomer is water-soluble. The free radical-generating catalyst is oil-soluble. In a water-bearing region of a hydrocarbon-bearing formation, the free radical-generating catalyst is configured to degrade into free radicals such that the free radicals are configured to initiate a polymerization reaction between the monomer and the bisacrylamide to form a polymer. The polymer is configured to inhibit water from permeating from the water-bearing region to a wellbore.

In some embodiments, the monomer includes an acrylamide monomer, an acrylate monomer, and combinations of the same. In some embodiments, the free radical-generating catalyst includes 2,2′-azobis(4-methoxy-2,4-dimethylvaleronitrile), 2,2′-azobis(2,4-dimethylvaleronitrile), 2,2′-azobis(isobutyronitrile), 2,2′-azobis (2-methylbutyronitrile), 1,1′-azobis(cyclohexane-1-carbonitrile), dimethyl 2,2′-azobis(2-methylpropionate), 2,2′-azobis (N-butyl-2-methylpropionamide), and combinations of the same.

Embodiments provide a method for controlling excess water production for hydrocarbon recovery. The method includes the step of introducing a monomer, an oxidizing agent, and an ammonium salt into a hydrocarbon-bearing formation via a wellbore. The method includes the step of polymerizing the monomer using the acid catalyst to form a resin. The acid catalyst is formed by the oxidizing agent and the ammonium salt reacting in a water-bearing region of the hydrocarbon-bearing formation. The resin inhibits water from permeating from the water-bearing region to the wellbore.

In some embodiments, the monomer includes a furan-based alcohol, a furan-based aldehyde, a formaldehyde-based monomer, a ketone-based monomer, a phenol-based monomer, a methylol-based monomer, and combinations of the same. In some embodiments, the oxidizing agent includes a peroxide, a persulfate salt, a permanganate salt, a bromate salt, a perbromate salt, a chlorate salt, a perchlorate salt, an iodate salt, a periodate salt, and combinations of the same. In some embodiments, the ammonium salt includes ammonium halides, ammonium sulfate, ammonium sulfonate, ammonium nitrate, ammonium phosphate, ammonium monohydrogen phosphate, ammonium dihydrogen phosphate, ammonium phosphite, ammonium nitrite, ammonium persulfate, ammonium carbonate, and combinations of the same. In some embodiments, the ammonium salt includes an N-substituted ammonium cation.

Embodiments provide a treatment fluid composition for controlling excess water production for hydrocarbon recovery. The treatment fluid composition includes a monomer, an oxidizing agent, and an ammonium salt. The oxidizing agent and the ammonium salt are configured to undergo a reaction in a water-bearing region of a hydrocarbon-bearing formation to form an acid catalyst. The acid catalyst is configured to catalyze polymerization of the monomer to form a resin. The resin is configured to inhibit water from permeating from the water-bearing region to a wellbore.

In some embodiments, the monomer includes a furan-based alcohol, a furan-based aldehyde, a formaldehyde-based monomer, a ketone-based monomer, a phenol-based monomer, a methylol-based monomer, and combinations of the same. In some embodiments, the oxidizing agent includes a peroxide, a persulfate salt, a permanganate salt, a bromate salt, a perbromate salt, a chlorate salt, a perchlorate salt, an iodate salt, a periodate salt, and combinations of the same. In some embodiments, the ammonium salt includes ammonium halides, ammonium sulfate, ammonium sulfonate, ammonium nitrate, ammonium phosphate, ammonium monohydrogen phosphate, ammonium dihydrogen phosphate, ammonium phosphite, ammonium nitrite, ammonium persulfate, ammonium carbonate, and combinations of the same. In some embodiments, the ammonium salt includes an N-substituted ammonium cation.

### BRIEF DESCRIPTION OF THE DRAWINGS

So that the manner in which the previously-recited features, aspects, and advantages of the embodiments of this disclosure as well as others that will become apparent are attained and can be understood in detail, a more particular description of the disclosure briefly summarized previously may be had by reference to the embodiments that are illustrated in the drawings that form a part of this specification. However, it is to be noted that the appended drawings illustrate only certain embodiments of the disclosure and are not to be considered limiting of the disclosure's scope as the disclosure may admit to other equally effective embodiments.

FIGURE is a photographic representation of a gelled treatment fluid composition in accordance with an embodiment of this disclosure.

In the accompanying FIGURE, similar components or features, or both, may have a similar reference label.

### DETAILED DESCRIPTION

The disclosure refers to particular features, including compositions, processes, or method steps. Those of skill in the art understand that the disclosure is not limited to or by the description of embodiments given in the specification. The subject matter of this disclosure is not restricted except only in the spirit of the specification and appended claims.

Those of skill in the art also understand that the terminology used for describing particular embodiments does not limit the scope or breadth of the embodiments of the disclosure. In interpreting the specification and appended claims, all terms should be interpreted in the broadest possible manner consistent with the context of each term. All technical and scientific terms used in the specification and appended claims have the same meaning as commonly understood by one of ordinary skill in the art to which this disclosure belongs unless defined otherwise. Like numbers refer to like elements throughout the disclosure.

Although the disclosure has been described with respect to certain features, it should be understood that the features and embodiments of the features can be combined with other features and embodiments of those features.

Although the various embodiments have been described in detail, it should be understood that various changes, substitutions, and alternations can be made without departing from the principle and scope of these embodiments. Accordingly, the scope of the various embodiments should be determined by the following claims and their appropriate legal equivalents.

As used throughout the disclosure, the singular forms “a,” “an,” and “the” include plural references unless the context clearly indicates otherwise.

As used throughout the disclosure, the word “about” includes +/−5% of the cited magnitude.

As used throughout the disclosure, the words “comprise,” “has,” “includes,” and all other grammatical variations are each intended to have an open, non-limiting meaning that does not exclude additional elements, components or steps. Embodiments of the present disclosure may suitably “comprise,” “consist,” or “consist essentially of” the limiting features disclosed, and may be practiced in the absence of a limiting feature not disclosed. For example, it can be recognized by those skilled in the art that certain steps can be combined into a single step.

Optional or optionally means that the subsequently described event or circumstances can or may not occur. The description includes instances where the event or circumstance occurs and instances where it does not occur.

Where a range of values is provided in the specification or in the appended claims, it is understood that the interval encompasses each intervening value between the greater limit and the lesser limit as well as the greater limit and the lesser limit. The disclosure encompasses and bounds smaller ranges of the interval subject to any specific exclusion provided. “Substantial” means equal to or greater than 1% by the indicated unit of measure. “Significant” means equal to or greater than 0.1% of the indicated unit of measure. “Detectable” means equal to or greater than 0.01% by the indicated unit of measure.

Where reference is made in the specification and appended claims to a method comprising two or more defined steps, the defined steps can be carried out in any order or simultaneously except where the context excludes that possibility.

As used throughout the disclosure, terms such as “first” and “second” are arbitrarily assigned and are merely intended to differentiate between two or more elements of a method. It is to be understood that the words “first” and “second” serve no other purpose and are not part of the name or description of the element, nor do they necessarily define a relative sequence of the element. Furthermore, it is to be understood that that the mere use of the term “first” and “second” does not require that there be any “third” component, although that possibility is contemplated under the scope of the present disclosure.

As used throughout the disclosure, spatial terms describe the relative position of an object or a group of objects relative to another object or group of objects. The spatial relationships apply along vertical and horizontal axes. Orientation and relational words, including “uphole,” “downhole,” and other like terms, are for descriptive convenience and are not limiting unless otherwise indicated.

As used throughout the disclosure, the term “water” can include, for example, a brine, a connate water, surface water, distilled water, carbonated water, produced water, pond water, ground water, treated municipal waste water, sea water, treated water, and combinations of the same.

As used throughout the disclosure, the term “latent acid” refers to a chemical composition for the controlled release of acid for acid-catalyzed polymerization. For example, a latent acid can include hydroxylamine and its acid salt derivatives. The acid salt derivatives of hydroxylamine include hydroxylammonium sulfate, hydroxylammonium phosphate, hydroxylammonium phenol sulfonate, and hydroxylammonium p-toluene sulfonate. While existing in their intact form, hydroxylamine and its acid salt derivatives may hinder acid-catalyzed curing process of a polymerization reaction. Upon thermal decomposition of hydroxylamine and its acid salt derivatives, the acid-catalyzed curing process is no longer hindered such that polymerization occurs. A latent acid can also include an ester, where upon hydrolysis, the ester transforms to its conjugate acid form configured to initiate and catalyze the acid-catalyzed curing process of a polymerization reaction. A latent acid can also include organic anhydrides, such as acetic anhydride and maleic anhydride. A latent acid can also include orthoesters, such as trimethyl orthoformate, trimethyl orthoacetate, triethyl orthoacetate, and polyorthoesters. A latent acid can also include amides.

As used throughout the disclosure, the term “latent base” refers to a chemical composition for the controlled release of base for base-catalyzed polymerization. For example, a latent base can include a metal oxide such as magnesium oxide, a substituted carbonate salt of a quaternary ammonium compound, and polyaspartic acid. The substituted carbonate salt has a carbonyl group, an alkoxy group, and a negative oxygen atom. The alkoxy group may have a hydrogen, alkyl, or aralkyl group. The cation of the substituted carbonate salt is a quaternary ammonium, where same or different alkyl, aryl, or aralkyl groups are covalently bound to the nitrogen atom of the quaternary ammonium. In some embodiments, polymers are covalently bound to the nitrogen atom of the quaternary ammonium. Non-limiting examples of the substituted carbonate salt of the quaternary ammonium compound include didecyldimethyl ammonium methocarbonate, dodecyltrimethyl ammonium methocarbonate, dioctyldimethyl ammonium methocarbonate, octadecyltrimethyl ammonium methocarbonate, dioctadecyldimethyl ammonium methocarbonate, and trioctylmethyl ammonium methocarbonate.

As used throughout the disclosure, the term “prepolymer” refers to a monomer or a combination of chemically linked monomers that exist in an intermediately cured state. A prepolymer can undergo further polymerization to form a fully cured or hardened polymer.

As used throughout the disclosure, the term “oligomer” refers to a combination of more than one chemically linked monomers. An oligomer is a compound intermediate between a monomer and a polymer. An oligomer may have similar properties of a prepolymer.

As used throughout the disclosure, the term “crosslinking” refers to a reaction involving sites or groups on existing oligomers or polymers, or an interaction between existing oligomers or polymers that results in the formation of a small region in a macromolecule from which at least two chains emanate.

As used throughout the disclosure, the term “curing” refers to a chemical process of converting a prepolymer or a polymer into a polymer of higher molar mass and then into a network.

Embodiments disclosed here are examples of a treatment fluid composition that is used in a wellbore that significantly reduces water production while minimally sacrificing oil and gas production. The treatment fluid composition is also used to control excess water production from a hydrocarbon-bearing formation.

In some embodiments, the treatment fluid composition includes a mixture of a monomer and a latent acid. The latent acid may include an ester. Optionally, an additive can be included in the treatment fluid composition. It is within the capability of those skilled in the art to determine molar ratios between the monomer, the latent acid, and the optional additive. In other embodiments, the treatment fluid composition includes a mixture of a prepolymer or an oligomer and the latent acid.

In some embodiments, the treatment fluid composition includes a monomer. The monomer is operable to undergo a polymerization reaction to form a resin-type polymer (referred to as a resin throughout this disclosure). The resin can be formed by a homopolymerization reaction where a single type of monomer is polymerized to form a homopolymer. The resin can also be formed by a copolymerization reaction where two or more different types of monomers are polymerized to form a copolymer. The resin can be formed by a polymerization reaction of a prepolymer or an oligomer.

In some embodiments, the resin is furan-based. Non-limiting examples of furan-based resins include furfuryl alcohol homopolymers, furfuryl alcohol-furfural copolymers, furfuryl alcohol-aldehyde copolymers, furfural-ketone copolymers, furfural-phenol copolymers, furfuryl alcohol-urea copolymers, and a furfuryl alcohol-phenol copolymers.

In some embodiments, the monomer includes a furan-based monomer. Non-limiting examples of suitable furan-based monomers include furan, furfural, furfuryl alcohol, 5-hydroxymethyl-2-furancarboxyaldehyde, 5-methyl-2-furancarboxyaldehyde, 2-vinyl furoate, 5-methyl-2-vinylfuroate, 5-tertbutyl-2-vinyl furoate, 2-furfurylmethacrylate, 2-furfuryl methylmethacrylate, 2-vinyl furan, 5-methyl-2-vinyl furan, 2-(2-propylene)furan (or 2-methyl vinylidene furan), 5-methyl-2-methyl vinylidenefuran, furfurylidene acetone, 5-methyl-2-furfurylidene acetone, 2-vinyl tetrahydrofuran, 2-furyl oxirane, 5-methyl-2-furyloxirane, furfuryl vinyl ether, 5-methyl-furfuryl vinyl ether, vinyl 2-furyl ketone, 2,5-bis(carboxyaldehyde) furan, 2,5-bis(hydroxymethyl) furan, 5-hydroxymethyl-2-ethyl furanacrylate, 2,5-furandicarboxylic acid, 5-hydroxymethyl-2-furan carboxylic acid, 2,5-furan diacid dichloride, 2,5-furan dicarboxylic acid dimethyl ester, 2,5-furan methylamine, 5-carboxy-2-furan amine, 5-methylester-2-furan amine, 2,5-bis(methylene isocyanate) furan, 2,5-bis(isocyanate) furan, 2-isocyanate furyl, and 2-methylene isocyanate furyl.

In some embodiments, the monomer includes a furan-based alcohol. A furan-based alcohol includes a furan having one or more hydrogens substituted with one or more hydroxyalkyl groups. Non-limiting examples of the furan-based alcohol include furfuryl alcohol, 3-furanmethanol, 2,5-bis(hydroxymethyl)furan, and derivatives of the same. A furan-based alcohol having a longer hydroxyalkyl group than furfuryl alcohol may have a greater flash point than that of furfuryl alcohol (75 deg. C.). In some embodiments, monomers having a relatively greater flash point than furfuryl alcohol may exhibit properties that promote safer operations in the field than using monomers having a flash point lesser than 75 deg. C. In other embodiments, prepolymeric or oligomeric forms of the furan-based alcohol can be used for the safe operation in the field. These furan-based alcohol prepolymers or oligomers have a relatively greater flash point than the monomeric forms of the same.

In some embodiments, the furan-based alcohol monomer can undergo a homopolymerization reaction to form a furan-based resin. The homopolymerization reaction of the furan-based alcohol monomer can be acid-catalyzed. The homopolymerization reaction of the furan-based alcohol monomer can be acid-catalyzed by a carboxylic acid or sulfonic acid produced as a result of ester hydrolysis or decomposition of the latent acid. Non-limiting examples of this type of furan-based resin include furfuryl alcohol homopolymers.

In other embodiments, furan-based alcohol prepolymers or oligomers can undergo a polymerization reaction to form the furan-based resin. The polymerization reaction of the furan-based alcohol prepolymers or oligomers can be acid-catalyzed. The polymerization reaction of the furan-based alcohol prepolymers or oligomers can be acid-catalyzed by a carboxylic acid or sulfonic acid produced as a result of ester hydrolysis or decomposition of the latent acid.

In some embodiments, the furan-based resin can be formed by methylene bridging. Non-limiting examples of resins formed by methylene bridging include furfuryl alcohol resins.

In some embodiments, monomers, prepolymers, or oligomers of furfuryl alcohol undergo polymerization where the resulting furfuryl alcohol resin have methylene (—CH₂) groups placed between two furan moieties. In an example embodiment of the method, furfuryl alcohol can be mixed with an ester or a latent acid to form a mixture. The mixture is typically oil-soluble such that the mixture has a consistency comparable to oil. Having an oil-like consistency allows the mixture to be delivered into the formation beyond the interface between the wellbore wall and the formation. The mixture can be introduced in the formation to selectively block water production. The mixture is introduced in the formation such that ester hydrolysis or decomposition of the latent acid produce acid to initiate polymerization. Ester hydrolysis or decomposition of the latent acid occur in a water-bearing region of the formation where the produced carboxylic acid or sulfonic acid catalyze the polymerization reaction of furfuryl alcohol. In an oil-bearing region of the formation, ester hydrolysis or decomposition of the latent acid minimally occur or do not occur, where furfuryl alcohol monomers may be transported back to the surface along with the produced oil. This way, the water-bearing region of the formation is selectively plugged.

In some embodiments, the furan-based resin can be formed by addition polymerization. For example, in the presence of an acid, furfuryl alcohol polymerization may occur not only through methylene bridging, but also by a monomer, prepolymer, or oligomer attaching to the π-conjugated ring structure of the aromatic furan moiety.

In some embodiments, the monomer, prepolymer, or oligomer include a furan-based aldehyde. A furan-based aldehyde includes a furan having one or more hydrogens substituted with one or more aldehyde groups. Non-limiting examples of the furan-based aldehyde include furfural, 3-furaldehyde, 2,5-furandicarboxaldehyde, and derivatives of the same. A furan-based aldehyde having a longer alkylcarbonyl group than furfuryl alcohol may have a greater flash point than that of furfural (62 deg. C.). In some embodiments, monomers having a relatively greater flash point than furfural may exhibit properties that promote safer operations in the field than using monomers having a flash point lesser than 62 deg. C.

In some embodiments, the furan-based aldehyde monomer can undergo a homopolymerization reaction to form a furan-based resin. The homopolymerization reaction of the furan-based aldehyde monomer can be acid-catalyzed. The homopolymerization reaction of the furan-based aldehyde monomer can be acid-catalyzed by a carboxylic acid or sulfonic acid produced as a result of ester hydrolysis or decomposition of the latent acid. Non-limiting examples of this type of furan-based resin include furfural homopolymers.

In other embodiments, furan-based aldehyde prepolymers or oligomers can undergo a polymerization reaction to form the furan-based resin. The polymerization reaction of the furan-based aldehyde prepolymers or oligomers can be acid-catalyzed. The polymerization reaction of the furan-based aldehyde prepolymers or oligomers can be acid-catalyzed by a carboxylic acid or sulfonic acid produced as a result of ester hydrolysis or decomposition of the latent acid. In some embodiments, the furan-based alcohol monomer and the furan-based aldehyde monomer can undergo a copolymerization reaction to form a furan-based resin. The copolymerization reaction of the furan-based alcohol monomer and the furan-based aldehyde monomer can be acid-catalyzed. The copolymerization reaction of the furan-based alcohol monomer and the furan-based aldehyde monomer can be acid-catalyzed by a carboxylic acid or sulfonic acid produced as a result of ester hydrolysis or decomposition of the latent acid. Non-limiting examples of this type of furan-based resin include furfuryl alcohol-furfural copolymers.

In other embodiments, furan-based alcohol monomers, prepolymers, or oligomers and furan-based aldehyde monomers, prepolymers, or oligomers can undergo a copolymerization reaction to form the furan-based resin. The copolymerization reaction of the furan-based alcohol monomers, prepolymers, or oligomers and the furan-based aldehyde monomers, prepolymers, or oligomers can be acid-catalyzed. The copolymerization reaction of the furan-based alcohol monomers, prepolymers, or oligomers and the furan-based aldehyde monomers, prepolymers, or oligomers can be acid-catalyzed by a carboxylic acid or sulfonic acid produced as a result of ester hydrolysis or decomposition of the latent acid.

In some embodiments, the monomer includes a formaldehyde-based monomer. The formaldehyde-based monomer can be formaldehyde or a substituted aldehyde. Non-limiting examples of substituted aldehyde include furfural. In other embodiments, formaldehyde-based prepolymers or oligomers can be used.

In some embodiments, the furan-based alcohol monomer and the formaldehyde-based monomer can undergo a copolymerization reaction to form a furan-based resin. The copolymerization reaction of the furan-based alcohol monomer and the formaldehyde-based monomer can be acid-catalyzed. The copolymerization reaction of the furan-based alcohol monomer and the formaldehyde-based monomer can be acid-catalyzed by a carboxylic acid or sulfonic acid produced as a result of ester hydrolysis or decomposition of the latent acid. Non-limiting examples of this type of furan-based resin include furfuryl alcohol-aldehyde copolymers.

In other embodiments, furan-based alcohol monomers, prepolymers, or oligomers and the formaldehyde-based monomers, prepolymers, or oligomers can undergo a polymerization reaction to form the furan-based resin. The polymerization reaction of the furan-based alcohol monomers, prepolymers, or oligomers and the formaldehyde-based monomers, prepolymers, or oligomers can be acid-catalyzed. The polymerization reaction the furan-based alcohol monomers, prepolymers, or oligomers and the formaldehyde-based monomers, prepolymers, or oligomers can be acid-catalyzed by a carboxylic acid or sulfonic acid produced as a result of ester hydrolysis or decomposition of the latent acid.

In some embodiments, the monomer includes a ketone-based monomer. The ketone-based monomer includes a ketone group and can be a substituted ketone. Non-limiting examples of the ketone-based monomer include acetone. In other embodiments, ketone-based prepolymers or oligomers can be used.

In some embodiments, the furan-based aldehyde monomer and the ketone-based monomer can undergo a copolymerization reaction to form a furan-based resin. The copolymerization reaction of the furan-based aldehyde monomer and the ketone-based monomer can be acid-catalyzed. The copolymerization reaction of the furan-based aldehyde monomer and the ketone-based monomer can be acid-catalyzed by a carboxylic acid or sulfonic acid produced as a result of ester hydrolysis or decomposition of the latent acid. Non-limiting examples of this type of furan-based resin include furfural-ketone copolymers.

In other embodiments, furan-based aldehyde monomers, prepolymers, or oligomers and ketone-based monomers, prepolymers, or oligomers can undergo a polymerization reaction to form the furan-based resin. The polymerization reaction of the furan-based aldehyde monomers, prepolymers, or oligomers and the ketone-based monomers, prepolymers, or oligomers can be acid-catalyzed. The polymerization reaction the furan-based aldehyde monomers, prepolymers, or oligomers and the ketone-based monomers, prepolymers, or oligomers can be acid-catalyzed by a carboxylic acid or sulfonic acid produced as a result of ester hydrolysis or decomposition of the latent acid.

In some embodiments, the monomer includes a phenol-based monomer. The phenol-based monomer can be a phenol or a substituted phenol. Non-limiting examples of substituted phenols include cresol, resorcinol, and cashew nutshell liquid distillate. In other embodiments, phenol-based prepolymers or oligomers can be used.

In some embodiments, the furan-based aldehyde monomer and the phenol-based monomer can undergo a copolymerization reaction to form a furan-based resin. The copolymerization reaction of the furan-based aldehyde monomer and the phenol-based monomer can be acid-catalyzed. The copolymerization reaction of the furan-based aldehyde monomer and the phenol-based monomer can be acid-catalyzed by a carboxylic acid or sulfonic acid produced as a result of ester hydrolysis or decomposition of the latent acid. Non-limiting examples of this type of furan-based resin include furfural-phenol copolymers.

In other embodiments, furan-based aldehyde monomers, prepolymers, or oligomers and phenol-based monomers, prepolymers, or oligomers can undergo a polymerization reaction to form the furan-based resin. The polymerization reaction of the furan-based aldehyde monomers, prepolymers, or oligomers and the phenol-based monomers, prepolymers, or oligomers can be acid-catalyzed. The polymerization reaction the furan-based aldehyde monomers, prepolymers, or oligomers and the phenol-based monomers, prepolymers, or oligomers can be acid-catalyzed by a carboxylic acid or sulfonic acid produced as a result of ester hydrolysis or decomposition of the latent acid.

In some embodiments, the furan-based resin can be formed by direct aldehyde condensation. Non-limiting examples of resins formed by direct aldehyde condensation include furfural-phenol resins.

In some embodiments, furfural reacts with phenol in the presence of an acid or a base to form a furan-based resin. In an example embodiment of the method, furfural and phenol (including substituted phenols) can be mixed with an ester or a latent acid (optionally in the presence of a solvent) to form a mixture. The mixture is typically oil-soluble such that the mixture has a consistency comparable to oil. Having an oil-like consistency allows the mixture to be delivered into the formation beyond the interface between the wellbore wall and the formation. Optionally, the furfural monomer can be accompanied with other chemical substances having ketone or aromatic amine groups to facilitate the polymerization reaction. The mixture can be introduced in the formation to selectively block water production. The mixture is introduced in the formation such that ester hydrolysis or decomposition of the latent acid produce acid to initiate polymerization. Ester hydrolysis or decomposition of the latent acid occur in a water-bearing region of the formation where the produced carboxylic acid or sulfonic acid catalyze the polymerization reaction of furfural and phenol. In an oil-bearing region of the formation, ester hydrolysis or decomposition of the latent acid minimally occur or do not occur, where furfural and phenol monomers may be transported back to the surface along with the produced oil. This way, the water-bearing region of the formation is selectively plugged. The molar ratio of furfural to phenol can range from about 1:1 to about 1:3. The resulting furan-based resin has a hardness comparable to a thermoset resin, coating material, or an adhesive. It is within the capability of those skilled in the art to choose different esters or latent acids having different hydrolysis or decomposition profiles used for different wells to tailor the resin setting time. In other embodiments, a latent base can be used to catalyze the polymerization reaction, where the latent base upon decomposition produces a base to initiate polymerization. In other embodiments, prepolymeric or oligomeric forms of furfural can be used. In other embodiments, prepolymeric or oligomeric forms of phenol can be used.

In some embodiments, the furan-based alcohol monomer and the phenol-based monomer can undergo a copolymerization reaction to form a furan-based resin. The copolymerization reaction of the furan-based alcohol monomer and the phenol-based monomer can be acid-catalyzed. The copolymerization reaction of the furan-based alcohol monomer and the phenol-based monomer can be acid-catalyzed by a carboxylic acid or sulfonic acid produced as a result of ester hydrolysis or decomposition of the latent acid. Non-limiting examples of this type of furan-based resin include furfuryl alcohol-phenol copolymers.

In other embodiments, furan-based alcohol monomers, prepolymers, or oligomers and phenol-based monomers, prepolymers, or oligomers can undergo a polymerization reaction to form the furan-based resin. The polymerization reaction of the furan-based alcohol monomers, prepolymers, or oligomers and the phenol-based monomers, prepolymers, or oligomers can be acid-catalyzed. The polymerization reaction the furan-based alcohol monomers, prepolymers, or oligomers and the phenol-based monomers, prepolymers, or oligomers can be acid-catalyzed by a carboxylic acid or sulfonic acid produced as a result of ester hydrolysis or decomposition of the latent acid. In some embodiments, the monomer includes a methylol-based monomer. The methylol-based monomer has one or more hydroxyl groups. Non-limiting examples of the methylol-based monomer include dimethylol urea, methylol phenols, and methylol melamines. In other embodiments, methylol-based prepolymers or oligomers can be used.

In some embodiments, the furan-based alcohol monomer and the methylol-based monomer can undergo a copolymerization reaction to form a furan-based resin. The copolymerization reaction of the furan-based alcohol monomer and the methylol-based monomer can be acid-catalyzed. The copolymerization reaction of the furan-based alcohol monomer and the methylol-based monomer can be acid-catalyzed by a carboxylic acid or sulfonic acid produced as a result of ester hydrolysis or decomposition of the latent acid. Non-limiting examples of this type of furan-based resin include furfuryl alcohol-urea copolymers.

In other embodiments, furan-based alcohol monomers, prepolymers, or oligomers and methylol-based monomers, prepolymers, or oligomers can undergo a polymerization reaction to form the furan-based resin. The polymerization reaction of the furan-based alcohol monomers, prepolymers, or oligomers and the methylol-based monomers, prepolymers, or oligomers can be acid-catalyzed. The polymerization reaction the furan-based alcohol monomers, prepolymers, or oligomers and the methylol-based monomers, prepolymers, or oligomers can be acid-catalyzed by a carboxylic acid or sulfonic acid produced as a result of ester hydrolysis or decomposition of the latent acid.

In some embodiments, the furan-based resin can be formed through ether linkages between monomers, prepolymers, or oligomers. For example, furfuryl alcohol monomers and dimethylol urea monomers may react to form a copolymer having ether groups between the two monomer units.

In some embodiments, furfuryl alcohol may form an ether linkage by reacting with hydroxyl groups of the methylol-based monomer. In an example embodiment of the method, furfuryl alcohol and dimethylol urea can be mixed with an ester or a latent acid to form a mixture. The mixture is typically oil-soluble, such that the mixture has a consistency comparable to oil, where the mixture can be delivered deep into the formation. The mixture can be introduced in the formation to selectively block water production. The mixture is introduced in the formation such that ester hydrolysis or decomposition of the latent acid produce acid to initiate polymerization. Ester hydrolysis or decomposition of the latent acid occur in a water-bearing region of the formation where the produced carboxylic acid or sulfonic acid catalyze the polymerization reaction of furfuryl alcohol and dimethylol urea. In an oil-bearing region of the formation, ester hydrolysis or decomposition of the latent acid minimally occur or do not occur, where furfuryl alcohol and dimethylol urea monomers may be transported back to the surface along with the produced oil. This way, the water-bearing region of the formation is selectively plugged. In other embodiments, prepolymeric or oligomeric forms of furfuryl alcohol can be used. In other embodiments, methylol-based prepolymers or oligomers can be used.

In some embodiments, the treatment fluid composition includes a latent acid. The latent acid can include an ester. Non-limiting examples of esters include esters of organic acids, such as organic carboxylic acid esters and organic sulfonic acid esters. These esters may exist in an aqueous solution or in a dispersed form in an aqueous environment. These esters can include alkyl groups such as methyl, ethyl, propyl, isobutyl groups. These esters can include aromatic groups such as aryl, benzyl, tolyl, phenyl, and xylyl groups.

In some embodiments, the ester may include organic carboxylic acid esters. Non-limiting examples of organic carboxylic acid esters include ester derivatives of malonic acid, succinic acid, maleic acid, oxalic acid, acetic acid, lactic acid, malic acid, tartaric acid, benzoic acid, and citric acid.

In some embodiments, the ester may include organic sulfonic acid esters. Non-limiting examples of organic sulfonic acid esters include alkylsulfonic acid esters, haloalkylsulfonic acid esters, imino sulfonates, imido sulfonates, alkyl p-toluenesulfonate, p-toluenesulfonic acid methyl ester, n-butyl p-toluenesulfonate, benzenesulfonic acid methyl ester, and methanesulfonic acid ethyl ester.

In some embodiments, the ester may include complex esters, for example polyesters. Non-limiting examples of complex esters include aliphatic polyesters, aromatic polyesters, polyhydroxybutyrates, polylactic acids, polyglycolic acids, orthoesters, polyorthoesters, polycaprolactones, polybutylene succinates, polyanhydrides, cellulose esters, cellulose acetates, and polyhydroxyalkanoates.

In some embodiments, ester hydrolysis can be acid-catalyzed in an aqueous environment where the carbonyl group of the ester becomes protonated and becomes susceptible to nucleophilic attack by water. On the other hand, ester hydrolysis can be base catalyzed in an aqueous environment where a hydroxide ion attacks the carbonyl group of the ester. The carboxylic acid or sulfonic acid formed as a result of ester hydrolysis releases protons to acid catalyze the polymerization of the monomer or monomers. Ester hydrolysis may occur at a pH close to 7 where wellbore conditions provide sufficient heat to initiate the reaction without a pH-based catalyst.

In some embodiments, the latent acid can include more than one ester. At a given temperature, the esters may have different hydrolysis rates depending on the chemical structures and concentrations of those esters. It is within the capability of those skilled in the art to control the kinetics of the carboxylic acid or sulfonic acid production by using a mixture of one or more esters. By controlling the production of the carboxylic acid or sulfonic acid that serves as an acid catalyst, one may control the kinetics of the polymerization of the monomer or monomers.

In an example embodiment of the method, the latent acid is placed, along with the monomer or monomers, prepolymer or prepolymers, or oligomer or oligomers, in or near the pores of the formation where the treatment fluid composition, upon polymerization becomes a gel or a solid. It is within the capability of those skilled in the art to determine the required delay time of polymerization based on the ester hydrolysis or decomposition profiles of the latent acid. Without being bound by any theory, the degree of hydrophobicity of the ester or the latent acid corresponds to a longer delay time of polymerization due to slower hydrolysis or decomposition kinetics. In some embodiments, the ester or the latent acid can be used at temperatures similar to or greater than wellbore conditions. In some embodiments, an ester having a relatively lesser degree of hydrophobicity can be used for plugging the water-bearing region of the formation due to having a faster hydrolysis kinetics than that of an ester having a relatively greater degree of hydrophobicity. In an example embodiment, the concentration of the latent acid is about 1 to about 100 parts by weight of the furan-based monomer.

In another example embodiment of the method, the latent acid includes a mixture of hydroxylamine and phenolsulfonic acid. The furan-based monomer, prepolymer, or oligomer are dissolved in oil and are introduced in the formation with the latent acid. Hydroxylamine operates as a retarder for the acid-catalyzed polymerization reaction where the phenolsulfonic acid is used as an acid catalyst. Similar to a downhole environment at or greater than 117 deg. C., hydroxylamine decomposes such that the retarding effect is no longer existent. The phenolsulfonic acid can then freely catalyze the polymerization of the furan-based monomer, prepolymer, or oligomer. In some embodiments, the latent acid includes a mixture of hydroxylamine and an organo-mineral acid. The acidic moiety of the organo-mineral acid includes sulfonic acid, phosphoric acid, phosphorous acid, sulfuric acid, nitric acid, nitrous acid, hydrochloric acid, hydrogluoric acid, hydrobromic acid, and sulfamic acid. The organic moiety of the organo-mineral acid includes hydrogen, a straight or branched chain alkyl group having 1 to 8 carbon atoms (portions optionally substituted by a halogen atom), and a phenyl or benzyl group. Portions of the phenyl or benzyl group are optionally substituted by a straight or branched chain, saturated or unsaturated alkyl group containing 1 to 8 carbon atoms, where portions of the alkyl group are optionally substituted by a hydroxy group or a halogen atom.

In some embodiments, the resin is a phenolic resin. Non-limiting examples of phenolic resins include resole-type resins and novolac-type resins.

In some embodiments, the monomer includes a phenol-based monomer and a formaldehyde-based monomer. The phenol-based monomer can be a phenol or a substituted phenol. Non-limiting examples of substituted phenol include cresol, resorcinol, and cashew nutshell liquid distillate. The formaldehyde-based monomer can be a formaldehyde or a substituted aldehyde. Non-limiting examples of substituted aldehyde include furfural. In other embodiments, phenol-based prepolymers or oligomers can be used. In other embodiments, formaldehyde-based prepolymers or oligomers can be used.

In some embodiments, the phenol-based monomer or oligomers and the formaldehyde-based monomer or oligomers can undergo a copolymerization reaction to form a phenolic resin such as a resole-type resin or a novolac-type resin. Resole-type resins have a stoichiometric ratio of formaldehyde to phenol of greater than one and can form a thermosetting polymer by heating. Novolac-type resins have a stoichiometric ratio of formaldehyde to phenol of less than one and typically exist in a prepolymer form. The prepolymer novolac-type resin does not crosslink, cure, or harden upon heating. The prepolymer novolac-type resin can be crosslinked, cured, or hardened by adding excess formaldehyde-based monomers or oligomers or hexamethylenetetramine in an amount greater than a 1:1 stoichiometric ratio of formaldehyde to phenol to form a thermoset resin. The prepolymer novolac-type resin can be crosslinked, cured, or hardened by adding a crosslinking agent and applying heat.

In some embodiments, the process of forming the thermoset resin can be accelerated by adding an acid catalyst. The acid catalyst allows the prepolymer novolac-type resin to be crosslinked, cured, or hardened at a lesser temperature than required in the absence of the acid catalyst. Non-limiting examples of the acid catalyst include organic acids such as oxalic acid, acetic acid, sulfonic acid, methanesulfonic acid, p-toluene sulfonic acid, benzoic acid, trichloroacetic acid, phosphoric acid, and formic acid, mineral acids such as hydrochloric acid, sulfuric acid, hydrofluoric acid, hydrobromic acid, boric acid, and derivatives of mineral acids such as boron trifluoride and tetrofluoro borate.

In some embodiments, oil-soluble phenolic resins can be formed by using phenol-based monomers or oligomers that includes substituted phenols. These substituted phenols may include a hydrocarbon substituent in the para-position to the hydroxyl group. Non-limiting examples of these substituted phenols include p-tert-butylphenol and p-phenylphenol. Without being bound by any theory, it is known that unsubstituted or minimally substituted phenols (such as substituted phenols having no substituents in the para-position) such as phenol, and o-/m-cresol likely do not produce phenolic resins that are oil-soluble. Without being bound by any theory, it is known that many of the oil-soluble phenolic resins are of the resole-type that can be hardened by applying heat.

In some embodiments, the novolac-type phenolic resin produced by the copolymerization reaction of the phenol-based monomer or oligomer and the formaldehyde-based monomer or oligomer can be acid catalyzed. The copolymerization reaction of the phenol-based monomer or oligomer and the formaldehyde-based monomer or oligomer can be acid catalyzed by a carboxylic acid or sulfonic acid produced as a result of ester hydrolysis or decomposition of the latent acid. The copolymer of the phenol-based monomer or oligomer and the formaldehyde-based monomer or oligomer resulting in a prepolymer novolac-type resin can be crosslinked, cured, or hardened by adding an acid catalyst. The acid catalyst allows the prepolymer novolac-type resin to be crosslinked, cured, or hardened at a lesser temperature than required in the absence of the acid catalyst. Non-limiting examples of the acid catalyst include organic and inorganic acids such as hydrochloric acid, sulfuric acid, nitric acid, phosphoric acid, hydrofluoric acid, hydrobromic acid, boric acid, sulfonic acid, methanesulfonic acid, benzene sulfonic acid, toluene sulfonic acid, p-toluene sulfonic acid, xylene sulfonic acid, napthalene sulfonic acid, oleic acid, benzoic acid, salicylic acid, formic acid, acetic acid, trichloroacetic acid, propionic acid, maleic acid, fumaric acid, oxalic acid, malonic acid, phthalic acid, lactic acid, succinic acid, glutaric acid, adipic acid, citric acid, tartaric acid, and levulinic acid. Non-limiting examples of the acid catalyst also include derivatives of inorganic acids such as boron trifluoride and tetrofluoro borate.

In some embodiments, the prepolymer novolac-type resin is mixed with excess formaldehyde-based monomers or oligomers or hexamethylenetetramine in the presence of the latent acid, then introduced in the formation to selectively block water production. Optionally, solvents can be used to at least partially dissolve the prepolymer novolac-type resin. The mixture is introduced in the formation such that ester hydrolysis or decomposition of the latent acid produce acid for further crosslinking, curing, or hardening. Ester hydrolysis or decomposition of the latent acid occur in a water-bearing region of the formation where the produced carboxylic acid or sulfonic acid catalyze the crosslinking, curing, or hardening of the prepolymer novolac-type resin. In an oil-bearing region of the formation, ester hydrolysis or decomposition of the latent acid minimally occur or do not occur, where the prepolymer novolac-type resin may be transported back to the surface along with the produced oil. This way, the water-bearing region of the formation is selectively plugged.

In some embodiments, the monomers, prepolymers, and oligomers described throughout this disclosure are generally oil-soluble. Monomeric alcohols described throughout this disclosure can be both water-soluble and oil-soluble. Prepolymers and oligomers described throughout this disclosure are sparingly soluble in water. The esters described throughout this disclosure are generally are oil-soluble. Without being bound by any theory, esters having a relatively lesser molecular weight can be water-soluble to some extent. However, these lesser molecular weight esters may hydrolyze in relatively lesser temperatures, such as a temperature comparable to room temperature. Without being bound by any theory, the degree of hydrophobicity of the ester generally corresponds to the degree of difficulty of the ester undergoing hydrolysis. Thus, an ester having a relatively greater degree of hydrophobicity would not undergo hydrolysis until it reaches a relatively greater temperature, such as a temperature comparable to a formation temperature.

In some embodiments, the treatment fluid composition includes a viscosity-enhancing additive to enhance its performance for controlling excess water production. The treatment fluid composition may include viscosity-enhancing additives to increase the viscosity of the fluid composition. The treatment fluid composition may include viscosity-enhancing additives to mitigate any unanticipated loss of the treatment fluid composition in the formation. The viscosity-enhancing additive can be dissolved, emulsified, suspended or dispersed in the treatment fluid composition. A gel composition can be used as the viscosity-enhancing additive include a gel composition. The gel composition can be oil based. The gel composition can be mineral oil based. The gel composition may include a crosslinked polymer. Clay can be used as the viscosity-enhancing additive. Non-limiting examples of clay include montmorillonite clay, aluminum pillared montmorillonite clay, M-I Wyoming clay, Cloisite® nanoclay, graphite, carbon nanotubes, graphene, and nanoparticles having metallic oxide.

In some embodiments, the treatment fluid composition includes a sealing additive. The sealing additive is configured to be used in conjunction with the furan-based resin to provide better sealing of fractures, vugs, channels, and perforations. Non-limiting examples of the sealing additive include powder or fiber forms of glass, silica, talc, kaolin, mica, and alumina. Clay can be used as the sealing additive. Non-limiting examples of clay include montmorillonite clay, aluminum pillared montmorillonite clay, M-I Wyoming clay, Cloisite® nanoclay, graphite, carbon nanotubes, and graphene. Non-limiting examples of the sealing additive further include aluminum hydroxide, calcium carbonate, silicates, zinc oxide, zirconium oxide and titanium oxide.

In some embodiments, the treatment fluid composition includes a solid acid additive. The solid acid additive includes solid acid particles. The solid acid additive can be dissolved, emulsified, suspended, or dispersed in the treatment fluid composition. Optionally, the solid acid additive can be dissolved, emulsified, suspended, or dispersed in the viscosity-enhancing additive. Non-limiting examples of the solid acid additive include solid or hydrated forms of organic and inorganic acids such as hydrochloric acid, sulfuric acid, nitric acid, phosphoric acid, hydrofluoric acid, hydrobromic acid, boric acid, sulfonic acid, methanesulfonic acid, benzene sulfonic acid, toluene sulfonic acid, p-toluene sulfonic acid, xylene sulfonic acid, napthalene sulfonic acid, oleic acid, benzoic acid, salicylic acid, formic acid, acetic acid, trichloroacetic acid, propionic acid, maleic acid, fumaric acid, oxalic acid, malonic acid, phthalic acid, lactic acid, succinic acid, glutaric acid, adipic acid, citric acid, tartaric acid, and levulinic acid. Non-limiting examples of the acid catalyst also include solid or hydrated forms of derivatives of inorganic acids such as boron trifluoride and tetrofluoro borate. Optionally, the solid acid additive can be a Lewis acid. Non-limiting examples of the Lewis acid include boron trifluoride, tin(IV) chloride, aluminum chloride, iron(III) chloride, and titanium(IV) chloride. When the solid acid additive is present in an aqueous environment, it may become dissolved such that protons are released to catalyze the polymerization reaction of the monomer or monomers. Optionally, when the latent acid and the solid acid additive are present in an aqueous environment, the solid acid additive may become dissolved such that protons are released to catalyze the ester hydrolysis or decomposition of the latent acid.

In some embodiments, the viscosity-enhancing additive is susceptible to basic substances such as sodium hydroxide and sodium carbonate. The presence of these basic substances may negatively affect the gel-type properties of the viscosity-enhancing additive. The addition of the solid acid additive may neutralize any basic substances present in the treatment fluid composition or in the formation.

In some embodiments, the treatment fluid composition includes a water-absorbing additive. The water-absorbing additive can be dissolved, emulsified, suspended, or dispersed in the treatment fluid composition. Due to viscous fingering, at least a portion of water penetrating into or through the resin can be absorbed by the water-absorbing additive. This way the integrity of the resin can be maintained. Non-limiting examples of the water-absorbing additive include superabsorbent polymers and homopolymers and copolymers having acrylamide monomer units. Superabsorbent polymers are polymers capable of absorbing and retaining liquid in an amount greater than their own weight. A non-limiting example of a superabsorbent polymer is hydrogel, where hydrogel may absorb water more than one hundred times of its weight.

In some embodiments, the treatment fluid composition includes a solvent used as a carrier fluid of the furan-based monomer or monomers. The solvent can also be used as a carrier fluid of the latent acid. In some embodiments, solvents can be used to thin, soften, or at least partially dissolve the produced furan-based resin in the formation. Non-limiting examples of the solvents include alcohols such as methanol and ethanol, glycols such as propylene glycol, dipropylene glycol monobutyl ether, propylene carbonate, mineral oil, diesel, crude oil, and liquid ethers. These solvents do not adversely affect the polymerization reaction catalyzed by the acid produced by ester hydrolysis or decomposition of the latent acid.

In some embodiments, the treatment fluid composition can include a coupling agent. The coupling agent is configured to form a chemical or physical bond with the surfaces of the formation. The coupling agent is also configured to form a chemical or physical bond with the produced resin. Non-limiting examples of the coupling agent include a silane-based compound having reactive terminal functional groups. Non-limiting examples of the silane-based compound include γ-glycidoxypropyltriethoxysilane, γ-aminopropyltriethoxysilane, γ-(methacryloxy)propyl trimethoxysilane, 3-acrylamidopropyltrimethoxysilane, 4-aminobutryltriethoxysilane, p-aminophenyltrimethoxysilane, carboxyethylsilanetriol sodium, 4-bromobutyltrimethoxysilane, 2-(chloromethyl)allyltrimethoxysilane, hydroxymethyltriethoxysilane, 3-isocyanotopropyltrimethoxysilane, 3-mercaptopropyltrimethoxysilane, and allyltrimethoxysilane.

In some embodiments, the treatment fluid composition can form acid-curable resins suitable for mitigating water production. Non-limiting examples of these acid-curable resins include amino resins, including etherified, esterified, or otherwise modified melamine resins, urea-formaldehyde resins, phenol-formaldehyde resins, and mixtures of such resins with alkyd, polyester, or acrylic resins. Non-limiting examples of these acid-curable resins include methylol compounds, methylol ethers of polycarboxylic acid imides, derivatives of polyacrylic or methacrylic acid, urethane alkyds, and resins which contain carboxylic acid esters of N-methylolimides. Non-limiting examples of acid catalysts used for curing these acid-curable resins are typically organic acids including sulfonic acids such as p-toluenesulfonic acid. In an example embodiment of the method, these acids are added to the acid-curable resin shortly before application to maintain the desired pot lives. As used throughout this disclosure, pot life refers to a period of time where viscosity of a mixed resin system doubles. Pot life is a measure of how rapid the mixed resin system cures. Gelation time can be controlled by mixing a latent acid to the acid-curable resin.

In some embodiments, the treatment fluid composition includes a mixture of an oil-soluble copolymer and a glycol ether solvent. It is within the capability of those skilled in the art to determine molar ratios between the copolymer and the glycol ether. The copolymer is insoluble in water. Non-limiting examples of the copolymer include an ethylene-propylene-styrene copolymer and an ethylene-butylene-styrene copolymer. The glycol ether solvent is water-soluble. Non-limiting examples of the glycol ether solvent includes 2-methoxyethanol, 2-ethoxyethanol, 2-propoxyethanol, 2-isopropoxyethanol, 2-butoxyethanol, 2-phenoxyethanol, 2-benzyloxyethanol, 1-methoxy-2-propanol, 2-(2-methoxyethoxy)ethanol, 2-(2-ethoxyethoxy)ethanol, and 2-(2-butoxyethoxy)ethanol. The copolymer can be dissolved, emulsified, suspended, or dispersed in the glycol ether solvent. When the treatment fluid composition is in contact with water, the glycol ether solvent will dissolve in water while leaving the copolymer to undergo precipitation.

In some embodiments, the treatment fluid composition can be utilized for the controlled delivery of an acid to a particular location of a wellbore. The treatment fluid composition provides in situ generation of acid to control the rate of the acid-catalyzed polymerization reaction and placement in a desired zone of the wellbore. In this manner, premature acid-catalyzed polymerization reactions (that can be exothermic) at locations other than the desired zone can be prevented.

In some embodiments, the treatment fluid composition includes an oxidizing agent. Non-limiting examples of the oxidizing agent can include a peroxide, a persulfate salt, a permanganate salt, a bromate salt, a perbromate salt, a chlorate salt, a perchlorate salt, an iodate salt, a periodate salt, and combinations of the same. In at least one embodiment, the oxidizing agent can include a bromate salt such as sodium bromate and potassium bromate, and a persulfate salt such as sodium persulfate and potassium persulfate. The oxidizing agent can be present in an aqueous environment. The oxidizing agent can have a concentration ranging between about 0.001 M to 10 M, alternately between about 0.01 M and about 2.4 M, or alternately between about 0.1 M and about 0.5 M at 20 deg. C. Optionally, the oxidizing agent can be encapsulated by means known in the art to delay its release into the treatment fluid composition.

In some embodiments, the oxidizing agent can be set to have a threshold temperature to react with other components of the treatment fluid composition. For example, the threshold temperature at atmospheric pressure can range between about ambient temperature and about 250 deg. C., or alternately between about 65 deg. C. and about 140 deg. C. Optionally, the threshold temperature can be reduced by adding a certain quantity of an acid to the treatment fluid composition.

In some embodiments, the treatment fluid composition includes an ammonium salt. The anionic component of the ammonium salt is oxidation resistant. The anionic component can be selected based on its reactivity, as measured by the temperature at which the resulting ammonium salt can react with a particular oxidizing agent. Non-limiting example ammonium salts include ammonium halides, ammonium sulfate, ammonium sulfonate, ammonium nitrate, ammonium phosphate, ammonium monohydrogen phosphate, ammonium dihydrogen phosphate, ammonium phosphite, ammonium nitrite, ammonium persulfate, ammonium carbonate, and combinations of the same. In some embodiments, the ammonium salt can include an N-substituted ammonium cation. For example, the N-substituted ammonium can be mono-substituted, di-substituted, tri-substituted, or tetra-substituted with one, two, three, or four alkyl groups, respectively. Non-limiting example alkyl groups include methyl, ethyl, propyl, butyl, and the like. In some embodiments, the ammonium salt is in the absence of tri-substituted or tetra-substituted ammonium salt.

In some embodiments, the treatment fluid composition can have a pH at atmospheric pressure and at a temperature less than 65 deg. C. greater than 5, alternately greater than 6, alternately greater than 7, or alternately greater than 8.

In an example embodiment of operation, the treatment fluid composition is introduced downhole into a wellbore. The treatment fluid composition can be bullheaded into a hydrocarbon-bearing formation. The hydrocarbon-bearing formation can include a carbonate formation, a sandstone formation, or a shale formation. Due to the bullheading event, the treatment fluid composition can be positioned in a water-bearing region of the hydrocarbon-bearing formation. Due to the bullheading event, the treatment fluid composition can also be positioned in an oil-bearing region of the hydrocarbon-bearing formation. In an alternate embodiment, the treatment fluid composition can be introduced to the water-bearing region of the hydrocarbon bearing formation using delivery means such as coiled tubing, which may require a lesser quantity of the treatment fluid composition than bullheading.

Optionally, the water-bearing region of the hydrocarbon bearing formation can be flushed using a preflush fluid before the introduction of the treatment fluid composition. The preflush fluid can displace water adjacent to or surrounding the casing into the hydrocarbon bearing formation. The preflush fluid can displace water from the pores of the hydrocarbon bearing formation. A certain quantity of the preflush fluid is introduced such that the treatment fluid composition is not in contact with excess water. Non-limiting examples of the preflush fluid include methanol, ethanol, Dowanol™, acid-generating esters, mineral oil, diesel, oil, propylene carbonate. The flushing sequence eliminates excess water in the water-bearing region and leaves only a quantity of residual water which is enough for the latent acid of the treatment fluid composition to undergo ester hydrolysis or decomposition.

In the water-bearing region, the latent acid of the treatment fluid composition would undergo ester hydrolysis or decomposition to produce a carboxylic acid or a sulfonate acid. The carboxylic acid or sulfonate acid formed as a result of ester hydrolysis or decomposition of the latent acid release protons to acid-catalyze the polymerization of the monomer or monomers. The acid generation rate can be tailored depending on the hydrophobicity of different acids. For example, an ester having a relatively slow hydrolysis rate at reservoir temperatures can be used such that the treatment fluid composition can be placed in the targeted zone of the wellbore before premature hydrolysis. Once the monomer or monomers are polymerized to form a resin, the resin may plug any pore throats existing in the water-bearing region. Because water is no longer able to pass through the resin-plugged pore throats, water production can be reduced.

Also in the water-bearing region, the glycol ether solvent of the treatment fluid composition would dissolve in water while leaving the copolymer to undergo precipitation. The copolymer precipitate may plug any pore throats existing in the water-bearing region. Because water is no longer able to pass through the copolymer precipitate-plugged pore throats, water production can be reduced.

Also in the water-bearing region, the ammonium salt and the oxidizing agent of the treatment fluid composition react to produce an acid to acid-catalyze the polymerization of the monomer or monomers. Once the monomer or monomers are polymerized to form a resin, the resin may plug any pore throats existing in the water-bearing region. Because water is no longer able to pass through the resin-plugged pore throats, water production can be reduced.

In the oil-bearing region, the latent acid of the treatment fluid composition does not undergo ester hydrolysis due to the lack of water. Because the ester hydrolysis reaction does not occur, minimal or no carboxylic acids or sulfonic acids are produced. Because minimal or no carboxylic acids or sulfonic acids are produced in the oil-bearing region, the monomer or monomers minimally or do not undergo polymerization where the carboxylic acids or sulfonic acids serve as acid catalysts. Hence, minimal or no resin is produced. Instead, the latent acid, the monomer or monomers, and any optional additives may exist in the oil-bearing region as dissolved, emulsified, suspended, or dispersed in the oil.

Also in the oil-bearing region, the glycol ether solvent of the treatment fluid composition would be oil-soluble forming a mixture. The copolymer can be kept dissolved, emulsified, suspended, or dispersed in the glycol ether solvent-oil mixture. The copolymer can otherwise be dissolved, emulsified, suspended, or dispersed in the oil. In both cases, copolymer precipitation minimally occurs or does not occur.

Alternately, the treatment fluid composition can be positioned in a high permeability streak adjacent to a wellbore. Water via high permeability streaks can penetrate into the wellbore causing excess water production. The water existing in the high permeability streak allows the ester to undergo hydrolysis and produce carboxylic acids. A resin is produced by acid catalyzed polymerization of the monomer in the high permeability streak. The resin is configured to block any water permeating into the wellbore.

In some embodiments, the treatment fluid composition includes acrylamide or acrylate monomers. The treatment fluid composition also includes bisacrylamide (N,N′-methylenebisacrylamide) as a crosslinking agent. The monomers and bisacrylamide can be solubilized in water then emulsified in hydrophobic solvents such as diesel to produce an external phase. An oil-soluble free radical-generating catalyst is added to the external phase. The external phase is introduced in the formation. In a water-bearing region, the free radical-generating catalyst will gradually degrade into free radicals and subsequently initiate the crosslinking of the monomers to plug any pore throats existing in the water-bearing region. In the oil-bearing region, the external phase no longer exists as an emulsion due to the hydrophobic environment. Consequently, the oil-soluble free radical-generating catalyst is washed away such that the monomers do not undergo polymerization and become transported back to the surface along with the produced oil. This way, the water-bearing region of the formation is selectively plugged. Non-limiting examples of the free radical-generating catalyst includes 2,2′-azobis(4-methoxy-2,4-dimethylvaleronitrile), 2,2′-azobis(2,4-dimethylvaleronitrile), 2,2′-azobis(isobutyronitrile), 2,2′-azobis (2-methylbutyronitrile), 1,1′-azobis(cyclohexane-1-carbonitrile), dimethyl 2,2′-azobis(2-methylpropionate), and 2,2′-azobis (N-butyl-2-methylpropionamide). Free radicals are formed when the azo group is removed by forming nitrogen gas.

### Example 1

Four samples were prepared as shown in Table 1. For each sample, the chemicals listed in Table 1 in milliliters (mL) were loaded into a pressure tube, purged with nitrogen at atmospheric pressure, sealed, and heated in a heating bath at 300 deg. F. The mineral oil used in Sample 3 was M5049 by Finoric (Houston, Tex.) having a flash point of over 210 deg. F.

TABLE 1

| | Furfuryl | Benzyl | |
|---|---|---|---|
| Sample | alcohol (mL) | acetate (mL) | Other additives |
| 1 | 5 | 1 | DI water, 1 mL |
| 2 | 5 | 1 | Produced water, 1 mL |
| 3 | 5 | 1 | Mineral oil, 1 mL |
| 4 | 5 | 1 | None |

Table 2 shows water analysis of the produced water sample used in Sample 2 in milligrams per liter (mg/L).

TABLE 2

| | | |
|---|---|---|
| Boron | 280 | mg/L |
| Barium | 20 | mg/L |
| Calcium | 16,100 | mg/L |
| Iron | <1 | mg/L |
| Magnesium | 1,220 | mg/L |
| Potassium | 4,960 | mg/L |
| Silicon | <1 | mg/L |
| Sodium | 91,840 | mg/L |
| Strontium | 1,170 | mg/L |
| Chloride | 178,740 | mg/L |
| Sulfate | 400 | mg/L |
| Carbonate | <1 | mg/L |
| Bicarbonate | 130 | mg/L |
| Total Dissolved Solids (TDS) | 295,000 | mg/L |
| Total Hardness | 45,200 | mg/L |

| | |
|---|---|
| pH | 6.0 |

Sample 1 turned into a viscous gel in about 7 hours. The viscous gel had a dark color. Continuous heating for over an additional 7 hours converted the viscous gel into a solid. Sample 2 turned into a dark solid gel 100 in about 6 hours, as shown in FIGURE. Sample 2 remained a dark solid gel despite of continuous heating for over 6 hours. Samples 3 and 4 remained in liquid form after one day of heating.

### Example 2

A coreflow test was carried out. A sandstone core sample having a permeability of 1 to 5 millidarcys (mD) was loaded into a core holder. A confining pressure of 3,000 pounds per square inch (psi) and a back pressure of 1,000 psi were applied to the core sample. The coreflow test was carried out at 300 deg. F. Initial permeability of the core sample was measured with 2 weight percent (wt. %) aqueous potassium chloride (KCl) solution at a flow rate of 1 milliliter per minute (mL/min), then at 2 mL/min, then at 3 mL/min, and then at 4 mL/min. Produced water was then injected into the core sample in an amount of 2 to 3 pore volumes (PV). A 5:1 volume ratio of furfuryl alcohol and benzyl acetate mixture was then injected into the core sample in an amount of 2 to 3 PV. The injected fluids were then shut in overnight while maintaining the temperature at 300 deg. F. After the shut-in, permeability of the core sample was again measured with 2 wt. % aqueous KCl solution injected at 1 mL/min until stabilization. The regained permeability was measured to be less than 2% of the initially measured permeability.

### Example 3

A coreflow test was carried out. A sandstone core sample having a permeability of 1 to 5 mD was loaded into a core holder. A confining pressure of 3,000 psi and a back pressure of 1,000 psi were applied to the core sample. The coreflow test was carried out at 300 deg. F. Initial permeability of the core was measured with mineral oil (M5049 by Finoric, Houston, Tex.) at a flow rate of 0.25 mL/min, then at 0.50 mL/min, and then at 0.75 mL/min. A 5:1 volume ratio of furfuryl alcohol and benzyl acetate mixture was then injected into the core sample in an amount of 2 to 3 PV. The injected fluids were then shut in overnight while maintaining the temperature at 300 deg. F. After the shut-in, permeability of the core sample was again measured with mineral oil injected at 0.25 mL/min until stabilization. The regained permeability was measured to be substantially greater (over at least 12 times greater) than the regained permeability of the core sample in Example 2.

Embodiments of the disclosure described, therefore, are adapted to carry out the objects and attain the ends and advantages mentioned, as well as others that are inherent. While example embodiments of the disclosure have been given for purposes of disclosure, numerous changes exist in the details of procedures for accomplishing the desired results. These and other similar modifications will readily suggest themselves to those skilled in the art, and are intended to be encompassed within the spirit of the present disclosure and the scope of the appended claims.

What is claimed is:

1. A method for controlling excess water production for hydrocarbon recovery, the method comprising the steps of:
introducing a latent acid and a monomer into a hydrocarbon-bearing formation via a wellbore; and
polymerizing the monomer using an acid catalyst to form a resin,
where the acid catalyst is formed by hydrolysis of the latent acid in a water-bearing region of the hydrocarbon-bearing formation, and
where the resin inhibits water from permeating from the water-bearing region to the wellbore.

2. The method of claim 1, where the monomer is selected from the group consisting of: a furan-based alcohol, a furan-based aldehyde, a formaldehyde-based monomer, a ketone-based monomer, a phenol-based monomer, a methylol-based monomer, and combinations of the same.

3. The method of claim 1, where the latent acid is selected from the group consisting of: a carboxylic acid ester, a sulfonic acid ester, a polyester, an anhydride, an orthoester, and combinations of the same.

4. The method of claim 1, where the resin is a furan-based resin.

5. The method of claim 1, where the introducing step further includes introducing one selected from the group consisting of: a viscosity-enhancing additive, a sealing additive, a solid acid additive, a water-absorbing additive, a solvent, a coupling agent, and combinations of the same.

6. The method of claim 1, where the resin is a prepolymer novolac-type resin.

7. The method of claim 6, further comprising the step of:
curing the resin by applying heat and introducing one selected from the group consisting of: formaldehyde, hexamethylenetetramine, a crosslinking agent, and combinations of the same.

8. A method for controlling excess water production for hydrocarbon recovery, the method comprising the steps of:
introducing a latent acid and one or more of a prepolymer and an oligomer into a hydrocarbon-bearing formation via a wellbore; and
polymerizing the one or more of the prepolymer and the oligomer using an acid catalyst to form a resin,
where the acid catalyst is formed by hydrolysis of the latent acid in a water-bearing region of the hydrocarbon-bearing formation, and
where the resin inhibits water from permeating from the water-bearing region to the wellbore.

9. The method of claim 8, where the one or more of the prepolymer and the oligomer includes a monomer unit selected from the group consisting of: a furan-based alcohol, a furan-based aldehyde, a formaldehyde-based monomer, a ketone-based monomer, a phenol-based monomer, a methylol-based monomer, and combinations of the same.

10. The method of claim 8, where the latent acid is selected from the group consisting of: a carboxylic acid ester, a sulfonic acid ester, a polyester, an anhydride, an orthoester, and combinations of the same.

11. A method for controlling excess water production for hydrocarbon recovery, the method comprising the steps of:
introducing a latent acid and a monomer into a hydrocarbon-bearing formation via a wellbore, the latent acid comprising an acid catalyst and hydroxylamine;
decomposing the hydroxylamine; and
polymerizing the monomer using the acid catalyst to form a resin,
where the hydroxylamine, before decomposition, retards the polymerizing step, and
where the resin inhibits water from permeating from a water-bearing region of the hydrocarbon-bearing formation to the wellbore.

12. The method of claim 11, where the monomer is selected from the group consisting of: a furan-based alcohol, a furan-based aldehyde, a formaldehyde-based monomer, a ketone-based monomer, a phenol-based monomer, a methylol-based monomer, and combinations of the same.

13. A method for controlling excess water production for hydrocarbon recovery, the method comprising the steps of:
introducing a latent acid and one or more of a prepolymer and an oligomer into a hydrocarbon-bearing formation via a wellbore, the latent acid comprising an acid catalyst and hydroxylamine;
decomposing the hydroxylamine; and
polymerizing the one or more of a prepolymer and an oligomer using the acid catalyst to form a resin,
where the hydroxylamine, before decomposition, retards the polymerizing step, and
where the resin inhibits water from permeating from a water-bearing region of the hydrocarbon-bearing formation to the wellbore.

14. The method of claim 13, where the prepolymer includes a monomer unit selected from the group consisting of: a furan-based alcohol, a furan-based aldehyde, a formaldehyde-based monomer, a ketone-based monomer, a phenol-based monomer, a methylol-based monomer, and combinations of the same.

15. A treatment fluid composition for controlling excess water production for hydrocarbon recovery, the treatment fluid composition comprising:
a monomer; and
a latent acid,
where the latent acid is configured to undergo hydrolysis in a water-bearing region of a hydrocarbon-bearing formation to form an acid catalyst,
where the acid catalyst is configured to catalyze polymerization of the monomer to form a resin, and
where the resin is configured to inhibit water from permeating from the water-bearing region to a wellbore.

16. The treatment fluid composition of claim 15, where the monomer is selected from the group consisting of: a furan-based alcohol, a furan-based aldehyde, a formaldehyde-based monomer, a ketone-based monomer, a phenol-based monomer, a methylol-based monomer, and combinations of the same.

17. The treatment fluid composition of claim 16, where the furan-based alcohol is furfuryl alcohol.

18. The treatment fluid composition of claim 16, where the furan-based aldehyde is furfural.

19. The treatment fluid composition of claim 16, where the formaldehyde-based monomer is formaldehyde.

20. The treatment fluid composition of claim 16, where the phenol-based monomer is selected from the group consisting of: phenol, cresol, resorcinol, cashew nutshell liquid distillate, and combinations of the same.

21. The treatment fluid composition of claim 16, where the methylol-based monomer is selected from the group consisting of: dimethylol urea, methylol phenols, methylol melamines, and combinations of the same.

22. The treatment fluid composition of claim 15, where the latent acid is selected from the group consisting of: a carboxylic acid ester, a sulfonic acid ester, a polyester, an anhydride, an orthoester, and combinations of the same.

23. The treatment fluid composition of claim 22, where the carboxylic acid ester is an ester derived from a carboxylic acid selected from the group consisting of: malonic acid, succinic acid, maleic acid, oxalic acid, acetic acid, lactic acid, malic acid, tartaric acid, benzoic acid, citric acid, and combinations of the same.

24. The treatment fluid composition of claim 22, where the sulfonic acid ester is selected from the group consisting of: alkylsulfonic acid esters, haloalkylsulfonic acid esters, imino sulfonates, imido sulfonates, alkyl p-toluenesulfonate, p-toluenesulfonic acid methyl ester, n-butyl p-toluenesulfonate, benzenesulfonic acid methyl ester, methanesulfonic acid ethyl ester, and combinations of the same.

25. The treatment fluid composition of claim 22, where the polyester is selected from the group consisting of: aliphatic polyesters, aromatic polyesters, polyhydroxybutyrates, polylactic acids, polyglycolic acids, polyorthoesters, polycaprolactones, polybutylene succinates, polyanhydrides, cellulose esters, cellulose acetates, polyhydroxyalkanoates, and combinations of the same.

26. The treatment fluid composition of claim 22, where the anhydride is selected from the group consisting of: acetic anhydride, maleic anhydride, and combinations of the same.

27. The treatment fluid composition of claim 22, where the orthoester is selected from the group consisting of: trimethyl orthoformate, trimethyl orthoacetate, triethyl orthoacetate, polyorthoesters, and combinations of the same.

28. The treatment fluid composition of claim 15, further comprising:
an additive, the additive selected from the group consisting of: a viscosity-enhancing additive, a sealing additive, a solid acid additive, a water-absorbing additive, a solvent, a coupling agent, and combinations of the same.

29. A treatment fluid composition for controlling excess water production for hydrocarbon recovery, the treatment fluid composition comprising:
one or more of a prepolymer and an oligomer; and
a latent acid,
where the latent acid is configured to undergo hydrolysis in a water-bearing region of a hydrocarbon-bearing formation to form an acid catalyst,
where the acid catalyst is configured to catalyze polymerization of the one or more of the prepolymer and the oligomer to form a resin, and
where the resin is configured to inhibit water from permeating from the water-bearing region to a wellbore.

30. The treatment fluid composition of claim 29, where the one or more of the prepolymer and the oligomer includes a monomer unit selected from the group consisting of: a furan-based alcohol, a furan-based aldehyde, a formaldehyde-based monomer, a ketone-based monomer, a phenol-based monomer, a methylol-based monomer, and combinations of the same.

31. The treatment fluid composition of claim 29, where the latent acid is selected from the group consisting of: a carboxylic acid ester, a sulfonic acid ester, a polyester, an anhydride, an orthoester, and combinations of the same.

32. A treatment fluid composition for controlling excess water production for hydrocarbon recovery, the treatment fluid composition comprising:
a monomer; and
a latent acid,
where the latent acid comprises an acid catalyst and hydroxylamine,
where the hydroxylamine is configured to thermally decompose in a hydrocarbon-bearing formation,
where the acid catalyst is configured to catalyze polymerization of the monomer to form a resin upon decomposition of the hydroxylamine, and
where the resin is configured to inhibit water from permeating from a water-bearing region of the hydrocarbon-bearing formation to a wellbore.

33. The treatment fluid composition of claim 32, where the monomer is selected from the group consisting of: a furan-based alcohol, a furan-based aldehyde, a formaldehyde-based monomer, a ketone-based monomer, a phenol-based monomer, a methylol-based monomer, and combinations of the same.

34. A treatment fluid composition for controlling excess water production for hydrocarbon recovery, the treatment fluid composition comprising:
one or more of a prepolymer and an oligomer; and
a latent acid,
where the latent acid comprises an acid catalyst and hydroxylamine,
where the hydroxylamine is configured to thermally decompose in a hydrocarbon-bearing formation,
where the acid catalyst is configured to catalyze polymerization of the one or more of the prepolymer and the oligomer to form a resin upon decomposition of the hydroxylamine, and
where the resin is configured to inhibit water from permeating from a water-bearing region of the hydrocarbon-bearing formation to a wellbore.

35. The treatment fluid composition of claim 34, where the one or more of the prepolymer and the oligomer includes a monomer unit selected from the group consisting of: a furan-based alcohol, a furan-based aldehyde, a formaldehyde-based monomer, a ketone-based monomer, a phenol-based monomer, a methylol-based monomer, and combinations of the same.

36. A method for controlling excess water production for hydrocarbon recovery, the method comprising the steps of:
introducing a copolymer and a glycol ether solvent into a hydrocarbon-bearing formation via a wellbore, where the copolymer and the glycol ether solvent forms a mixture in the hydrocarbon-bearing formation; and
maintaining the mixture in the hydrocarbon-bearing formation until the glycol ether solvent dissolves in a water-bearing region of the hydrocarbon-bearing formation allowing the copolymer to undergo precipitation,
where the copolymer is oil-soluble, and
where the copolymer, upon precipitation, inhibits water from permeating from the water-bearing region to the wellbore.

37. The method of claim 36, where the copolymer is selected from the group consisting of: an ethylene-propylene-styrene copolymer, an ethylene-butylene-styrene copolymer, and combinations of the same.

38. The method of claim 36, where the glycol ether solvent is selected from the group consisting of: 2-methoxyethanol, 2-ethoxyethanol, 2-propoxyethanol, 2-isopropoxyethanol, 2-butoxyethanol, 2-phenoxyethanol, 2-benzyloxyethanol, 1-methoxy-2-propanol, 2-(2-methoxyethoxy)ethanol, 2-(2-ethoxyethoxy)ethanol, 2-(2-butoxyethoxy)ethanol, and combinations of the same.

39. A treatment fluid composition for controlling excess water production for hydrocarbon recovery, the treatment fluid composition comprising:
a copolymer; and
a glycol ether solvent,
where the glycol ether solvent is configured to dissolve in a water-bearing region of a hydrocarbon-bearing formation such that the copolymer undergoes precipitation, and
where the copolymer, upon precipitation, is configured to inhibit water from permeating from the water-bearing region of the hydrocarbon-bearing formation to a wellbore.

40. The treatment fluid composition of claim 39, where the copolymer is selected from the group consisting of: an ethylene-propylene-styrene copolymer, an ethylene-butylene-styrene copolymer, and combinations of the same.

41. The treatment fluid composition of claim 39, where the glycol ether solvent is selected from the group consisting of: 2-methoxyethanol, 2-ethoxyethanol, 2-propoxyethanol, 2-isopropoxyethanol, 2-butoxyethanol, 2-phenoxyethanol, 2-benzyloxyethanol, 1-methoxy-2-propanol, 2-(2-methoxyethoxy)ethanol, 2-(2-ethoxyethoxy)ethanol, 2-(2-butoxyethoxy)ethanol, and combinations of the same.

42. A method for controlling excess water production for hydrocarbon recovery, the method comprising the steps of:
introducing a monomer, bisacrylamide, and a free radical-generating catalyst into a hydrocarbon-bearing formation via a wellbore; and
polymerizing the monomer and the bisacrylamide using free radicals to form a polymer,
where the monomer is water-soluble,
where the free radical-generating catalyst is oil-soluble,
where the free radicals are formed by degradation of the free radical-generating catalyst in a water-bearing region of the hydrocarbon-bearing formation, and
where the polymer inhibits water from permeating from the water-bearing region to the wellbore.

43. The method of claim 42, where the monomer is selected from the group consisting of: an acrylamide monomer, an acrylate monomer, and combinations of the same.

44. The method of claim 42, where the free radical-generating catalyst is selected from the group consisting of: 2,2′-azobis(4-methoxy-2,4-dimethylvaleronitrile), 2,2′-azobis(2,4-dimethylvaleronitrile), 2,2′-azobis(isobutyronitrile), 2,2′-azobis (2-methylbutyronitrile), 1,1′-azobis(cyclohexane-1-carbonitrile), dimethyl 2,2′-azobis(2-methylpropionate), 2,2′-azobis (N-butyl-2-methylpropionamide), and combinations of the same.

45. A treatment fluid composition for controlling excess water production for hydrocarbon recovery, the treatment fluid composition comprising:
a monomer;
bisacrylamide; and
a free radical-generating catalyst,
where the monomer and the bisacrylamide is configured to be solubilized in a hydrophilic environment,
where an external phase is produced by emulsifying the monomer and the bisacrylamide in a hydrophobic environment,
where the monomer is water-soluble,
where the free radical-generating catalyst is oil-soluble,
where the free radical-generating catalyst, in a water-bearing region of a hydrocarbon-bearing formation, is configured to degrade into free radicals such that the free radicals are configured to initiate a polymerization reaction between the monomer and the bisacrylamide to form a polymer, and
where the polymer is configured to inhibit water from permeating from the water-bearing region to a wellbore.

46. The treatment fluid composition of claim 45, where the monomer is selected from the group consisting of: an acrylamide monomer, an acrylate monomer, and combinations of the same.

47. The treatment fluid composition of claim 45, where the free radical-generating catalyst is selected from the group consisting of: 2,2′-azobis(4-methoxy-2,4-dimethylvaleronitrile), 2,2′-azobis(24,-dimethylvaleronitrile), 2,2′-azobis(isobutyronitrile), 2,2′-azobis (2-methylbutyronitrile), 1,1′-azobis(cyclohexane-1-carbonitrile), dimethyl 2,2′-azobis(2-methylpropionate) 2,2′-azobis (N-butyl-2-methylpropionamide), and combinations of the same.

48. A method for controlling excess water production for hydrocarbon recovery, the method comprising the steps of:
introducing a monomer, an oxidizing agent, and an ammonium salt into a hydrocarbon-bearing formation via a wellbore; and
polymerizing the monomer using the acid catalyst to form a resin,
where the acid catalyst is formed by the oxidizing agent and the ammonium salt reacting in a water-bearing region of the hydrocarbon-bearing formation, and
where the resin inhibits water from permeating from the water-bearing region to the wellbore.

49. The method of claim 48, where the monomer is selected from the group consisting of: a furan-based alcohol, a furan-based aldehyde, a formaldehyde-based monomer, a ketone-based monomer, a phenol-based monomer, a methylol-based monomer, and combinations of the same.

50. The method of claim 48, where the oxidizing agent is selected from the group consisting of: a peroxide, a persulfate salt, a permanganate salt, a bromate salt, a perbromate salt, a chlorate salt, a perchlorate salt, an iodate salt, a periodate salt, and combinations of the same.

51. The method of claim 48, where the ammonium salt is selected from the group consisting of: ammonium halides, ammonium sulfate, ammonium sulfonate, ammonium nitrate, ammonium phosphate, ammonium monohydrogen phosphate, ammonium dihydrogen phosphate, ammonium phosphite, ammonium nitrite, ammonium persulfate, ammonium carbonate, and combinations of the same.

52. The method of claim 48, where the ammonium salt includes an N-substituted ammonium cation.

53. A treatment fluid composition for controlling excess water production for hydrocarbon recovery, the treatment fluid composition comprising:
a monomer;
an oxidizing agent; and
an ammonium salt,
where the oxidizing agent and the ammonium salt are configured to undergo a reaction in a water-bearing region of a hydrocarbon-bearing formation to form an acid catalyst,
where the acid catalyst is configured to catalyze polymerization of the monomer to form a resin, and
where the resin is configured to inhibit water from permeating from the water-bearing region to a wellbore.

54. The treatment fluid composition of claim 53, where the monomer is selected from the group consisting of: a furan-based alcohol, a furan-based aldehyde, a formaldehyde-based monomer, a ketone-based monomer, a phenol-based monomer, a methylol-based monomer, and combinations of the same.

55. The treatment fluid composition of claim 53, where the oxidizing agent is selected from the group consisting of: a peroxide, a persulfate salt, a permanganate salt, a bromate salt, a perbromate salt, a chlorate salt, a perchlorate salt, an iodate salt, a periodate salt, and combinations of the same.

56. The treatment fluid composition of claim 53, where the ammonium salt is selected from the group consisting of: ammonium halides, ammonium sulfate, ammonium sulfonate, ammonium nitrate, ammonium phosphate, ammonium monohydrogen phosphate, ammonium dihydrogen phosphate, ammonium phosphite, ammonium nitrite, ammonium persulfate, ammonium carbonate, and combinations of the same.

57. The treatment fluid composition of claim 53, where the ammonium salt includes an N-substituted ammonium cation.
